(19) United States
(12) Patent Application Publication
(10) Pub. No.: US 2021/0100172 A1
(43) Pub. Date: Apr. 8, 2021

(54) ACTIVE INDOOR PLANTING DYNAMIC CARBON DIOXIDE CONCENTRATION ADJUSTMENT SYSTEM

(71) Applicant: Allton Communication Co., Changhua County (TW)

(72) Inventor: Chao-Nung CHI, Changhua County (TW)

(21) Appl. No.: 16/665,530

(22) Filed: Oct. 28, 2019

(30) Foreign Application Priority Data
Oct. 2, 2019 (TW) 108135707

(51) Int. Cl. A01G 9/18; A01G 9/24; A01G 9/26

(52) U.S. Cl. CPC A01G 9/18; A01G 9/26; A01G 9/249

(57) ABSTRACT

An active indoor planting dynamic carbon dioxide concentration adjustment system includes a planting assembly, multiple variable light intensity illuminating devices, a carbon dioxide detector and a controller. The planting assembly is disposed in an indoor space, and the illuminating device is configured to illuminate the planting assembly according to a control signal to cause photosynthesis of the planting assembly. The carbon dioxide detector is configured to detect a carbon dioxide concentration in the indoor space and to emit a concentration signal. The controller is signally connected to the illuminating devices and the carbon dioxide detector, and is configured to receive the concentration signal and give the control signal. The controller dynamically adjusts the light intensity of the illuminating devices according to the concentration signal, thereby dynamically adjusting the efficiency of the photosynthesis of the planting assembly.

### BACKGROUND OF THE INVENTION

### Field of the Invention

The present invention relates generally to an air purification system, and more particularly to indoor carbon dioxide adjustment system by means of photosynthesis.

### Description of the Prior Art

Carbon dioxide, PM2.5 and volatile organic compounds (VOCs) are the three main causes of indoor air pollution. At present, most air purifiers are mainly used to process PM2.5 and some VOCs, but there is always a lack of treatment mechanism which can effectively reduce carbon dioxide. Besides, people are often not willing to open windows because the outdoors is too cold, too hot, too dirty or too noisy, resulting in an increase in indoor carbon dioxide concentration. When the carbon dioxide concentration exceeds 1000 ppm, it can cause people to feel drowsy. It is even harmful to human health if people stays in an environment with the carbon dioxide concentration of 3000-5000 ppm for a long time.

Offices and classrooms are prone to high carbon dioxide concentration. The carbon dioxide concentration in offices can reach as high as 2500 ppm, and the carbon dioxide concentration in classrooms ca even reach as high as 5000 ppm. Such a rich carbon dioxide environment not only affects work and learning efficiency, but also is also harmful to health.

Many people think that planting plants indoors can be useful to consume carbon dioxide exhaled by the human body, but two important facts are often neglected: (1) the rate of carbon dioxide consumed by indoor planting often fails to keep up with that produced by a group of people; (2) most landscape plants are unable to perform photosynthesis in high carbon dioxide concentrations, such as over 1200 ppm. Once indoor carbon dioxide concentration exceeds the tolerable concentration range of photosynthesis of the planting, the planting cannot help reduce indoor carbon dioxide concentration.

### SUMMARY OF THE INVENTION

In view of the foregoing, one object of the present invention is to provide a carbon dioxide concentration adjustment system capable of dynamically adjusting the photosynthesis efficiency of the planting to control the carbon dioxide concentration in a suitable interval.

To achieve the above and other objects, the present invention provides an active indoor planting dynamic carbon dioxide concentration adjustment system, which includes a planting assembly, multiple light-intensity-variable illuminating devices, a carbon dioxide detector and a controller. The planting assembly is disposed in an indoor space. The illuminating devices is configured to illuminate the planting assembly according to a control signal to cause photosynthesis of the planting assembly. The carbon dioxide detector is configured to detect a carbon dioxide concentration in the indoor space and to emit a concentration signal. The controller is signally connected to the illuminating devices and the carbon dioxide detector. The controllers configured to receive the concentration signal and to give the control signal. The controller is configured to dynamically adjust a light intensity of the illuminating devices according to the concentration signal, thereby dynamically adjusting a photosynthesis efficiency of the planting assembly.

The present invention can correspondingly and dynamically adjust the light intensity according to the carbon dioxide concentration signal feedback to the controller, so that the photosynthesis efficiency can be correspondingly increased when the carbon dioxide concentration increases, thereby avoiding or at least mitigate the situation that the indoor carbon dioxide concentration exceeds the standard.

### BRIEF DESCRIPTION OF THE DRAWINGS

FIG. 1 is a schematic diagram of the system of a first embodiment of the present invention;

FIG. 2 is a schematic diagram of a planting assembly of another embodiment of the present invention.

### DETAILED DESCRIPTION OF THE PREFERRED EMBODIMENTS

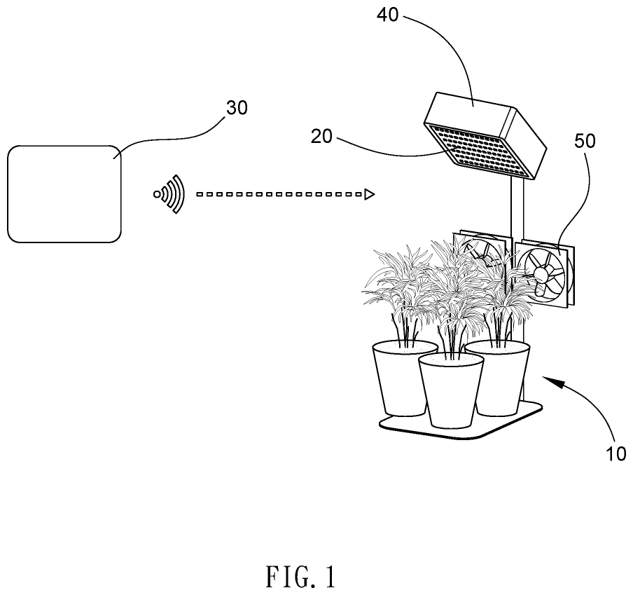

Please refer to FIG. 1 for an active indoor planting dynamic carbon dioxide adjustment system, hereinafter referred to as “adjustment system,” in accordance with the first embodiment of the present invention. The adjustment system can be used indoors and is configured to control indoor carbon dioxide concentration within a suitable range, e.g. less than 1000 ppm or even less than 600 ppm. The adjustment system includes a planting assembly 10, multiple light-intensity-variable illuminating devices 20, a carbon dioxide detector 30, a controller 40 and at least a fan 50.

The planting assembly 10 is disposed indoors and can be assembled with multiple plants. These plants may include single planting or multiple planting. As a possible option, the plants in the planting assembly are, for example, landscape plants, including but not limited to Western Rhododendron, Ivy, Calathea Makoyana, Aglaonema ‘White Tip’, Cyclamen, Dendrobium, Poinsettia, Anthurium, Pothos aurea, Heart-leaf Philodendron, Cordyline fruticosa ‘Baby Doll’, Arrow-head Vine and Fiddle-leaf Fig. As another possible option, plants in the planting assembly are, for example, floating aquatic plants, vanilla plants or other edible plants. In possible embodiments, the planting assembly is cultivated by hydroponics. Each plant type only performs photosynthesis in its specific carbon dioxide concentration range. Taking Ivy and an example, the appropriate carbon dioxide concentration range thereof is about 50-600 ppm. Exceeding this concentration range, Ivy cannot perform photosynthesis. Taking Poinsettia as another example, the appropriate carbon dioxide concentration range thereof is about 100-1200 ppm. Exceeding this concentration range, Poinsettia cannot perform photosynthesis. Therefore, in a preferred planting assembly, it normally contains multiple plants with complementary carbon dioxide concentration ranges. On the other hand, each plant type has its own light compensation point and light saturation point. When the light intensity reaches the light compensation point, the carbon dioxide consumed by plant photosynthesis is balanced with the carbon dioxide produced by respiration. When the light intensity reaches the light saturation point, the carbon dioxide consumed by plant photosynthesis reaches the maximum, and the plant photosynthesis will not increase even with further increased light intensity. When the light intensity is between the light compensation point and the light saturation point, the greater the light intensity, the higher the carbon dioxide consumed by photosynthesis. In addition, the higher the carbon dioxide concentration, the higher the light saturation point of the plant may be. In general, the light compensation point and light saturation point of the shade plants are lower than these of the sun plants, respectively. In high light intensity environments, the sun plants usually have a higher carbon dioxide consumption rate than the shade plants. Therefore, in a preferred planting assembly, plants with lower light compensation points are usually included to consume carbon dioxide even in low illumination. The planting assembly usually also includes plants with high light saturation point and high maximum carbon dioxide consumption rate as the main plants for consuming excessive indoor carbon dioxide.

The illuminating devices 20 can be individually illuminate the planting assembly according to a control signal to cause photosynthesis of the planting assembly. Suitable illuminating devices 20 can be but not limited to LEDs, incandescent lamps, fluorescent lights, high pressure gas discharge lamps and neon lights. The emitted light cannot only be visible light, but also invisible light such as ultraviolet light or infrared light. In possible embodiments, multiple illuminating devices can be placed on the same substrate, but controlled by independent control signals, e.g. multiple LEDs capable of independently controlled light emission embedded on the same substrate. In possible embodiments, the color temperature values or spectral values of the light emitted by the respective illuminating devices are pre-determined by the user. The light intensity is adjustable, for example, the LEDs can emit light with different intensities when different currents are given. The light-intensity-variable illuminating devices can emit different intensity light at different times according to the control signal.

The carbon dioxide detector 30 is disposed indoors and is configured to detect a carbon dioxide concentration in the indoor space and to emit a concentration signal. The controller 40 is signally connected with the carbon dioxide detector 30 and is configured to receive the concentration signal. In possible embodiments, carbon dioxide detector 30 is configured to detect the carbon dioxide concentration at a fixed time interval and emit the concentration signal, so that the controller 40 can determine a rate of increase or decrease of the carbon dioxide concentration based on the last two concentration signals.

The controller 40 is further signally connected with the illuminating devices and gives the control signals. More specifically, the controller 40 can dynamically adjust the light intensity of the illuminating devices 20 according to the concentration signal, thereby dynamically adjusting the photosynthesis efficiency of the planting assembly 10. For example, when the controller 40 determines the rate of increase of the carbon dioxide concentration based on the last two concentration signals, the controller 40 further causes a rate of carbon dioxide consumption which the planting assembly 10 additionally consumes due to the increase of the efficiency of photosynthesis to be not less than the rate of increase of the carbon dioxide concentration by means of increasing the light intensity of the illuminating devices 20, thereby avoiding or at least mitigate the rate of increase of indoor carbon dioxide concentration. On the other hand, when the controller 40 determines the indoor carbon dioxide concentration is lowering, the controller 40 can correspondingly lower the light intensity to reduce the efficiency of photosynthesis of the planting assembly so as to save energy.

In order to accurately provide control signals to adjust the efficiency of photosynthesis of the planting assembly, the controller 40 can be stored with photosynthesis related parameters of a variety of plants, a spatial volume parameter of the indoor space and its maximum number of users. The photosynthesis related parameters may include but not limit to the relationship between the light intensity and the photosynthesis efficiency of each plant, the tolerable carbon dioxide concentration range of photosynthesis of each plant, the mole number of oxygen produced per unit time of unit leaf area of each plant under specific light intensity and carbon dioxide concentration. On the other hand, the controller can determine the maximum carbon dioxide concentration increase rate in the indoor space according to the spatial volume parameter of the indoor space and its maximum number of users, thereby providing suggestion of suitable planting species and quantity of the planting assembly. The controller can also determine the relationship between the light intensity of the illuminating devices 20 and the efficiency of photosynthesis of the planting assembly 10 according to the planting species and quantity thereof with the reference of the photosynthesis related parameters. Thereby, the effect of correspondingly and dynamically adjusting the photosynthesis efficiency according to the concentration signal provided by the carbon dioxide detector 30 can be achieved.

The fan 50 is configured to blow air to the planting assembly 10 to blow away the oxygen generated by the photosynthesis of the plant assembly, preventing oxygen from staying around the plants and affecting photosynthesis efficiency. In possible embodiments, the fan 50 is signally connected to the controller 40, and the controller 40 can increase or decrease the rotational speed of the fan 50 according to the rate of increase or decrease of the carbon dioxide concentration, thereby dynamically adjusting the ability of the fan 50 to blow off oxygen. It is to be noted that the controller 40 may be wired or wirelessly connected to the illuminating devices 20, the carbon dioxide detector 30 and the fan 50.

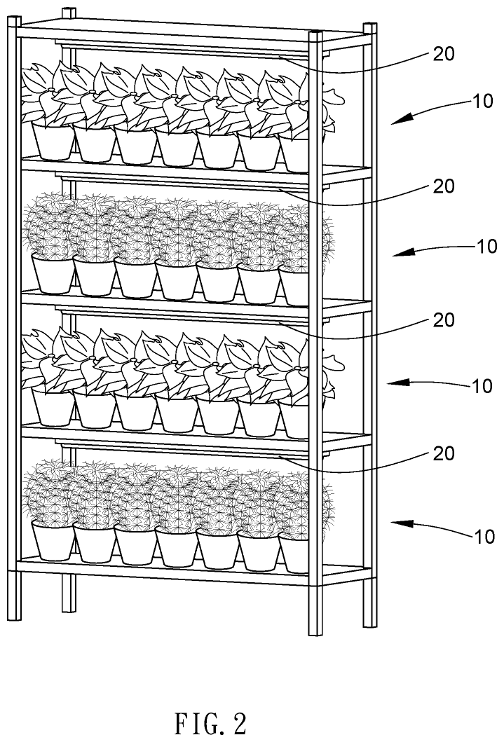

In the prior embodiment, the planting assembly 10 illustratively includes single plant type. In the embodiment shown in FIG. 2, the planting assembly 10 is placed on a multi-layered frame, each of which can be placed with the same or different plants, and each layer of plants is provided with illuminating devices atop of them. Thus, in possible embodiments, the illuminating devices 20 of each layer can be independently controlled such that the illuminating devices 20 at different layers can provide different light intensities.

Through the above design, the present invention can achieve the effects that the indoor carbon dioxide concentration can be actively and dynamically adjusted by the planting assembly, and the carbon dioxide concentration in the indoor space can be maintained within a suitable range, so as to allow users to breathe forest-like air even indoors. Other additional advantages of the present invention include the ability to simultaneously purify a variety of air pollutions other than carbon dioxide by plants and to improve aesthetics.

1. An active indoor planting dynamic carbon dioxide concentration adjustment system, comprising
a planting assembly, disposed in an indoor space;
multiple light-intensity-variable illuminating devices, configured to illuminate the planting assembly according to a control signal to cause photosynthesis of the planting assembly;
a carbon dioxide detector, configured to detect a carbon dioxide concentration in the indoor space and to emit a concentration signal; and
a controller, signally connected to the illuminating devices and the carbon dioxide detector, the controller being configured to receive the concentration signal and to give the control signal, and the controller being configured to dynamically adjust a light intensity of the illuminating devices according to the concentration signal, thereby dynamically adjusting a photosynthesis efficiency of the planting assembly;
wherein the carbon dioxide detector is configured to detect the carbon dioxide concentration at a fixed time interval and emit the concentration signal, the controller is configured to determine a rate of increase or decrease of the carbon dioxide concentration based on the last two concentration signals, the controller is further configured to correspondingly increase or decrease the light intensity of the illuminating devices according to the rate of increase or decrease of the carbon dioxide concentration, thereby correspondingly increasing or decreasing the efficiency of photosynthesis of the plant assembly.

2. (canceled)

3. The active indoor planting dynamic carbon dioxide adjustment system of claim 1, wherein when the controller determines the rate of increase of the carbon dioxide concentration based on the last two concentration signals, the controller further causes a rate of carbon dioxide consumption which the planting assembly additionally consumes due to the increase of the efficiency of photosynthesis to be not less than the rate of increase of the carbon dioxide concentration by means of increasing the light intensity.

4. An active indoor planting dynamic carbon dioxide adjustment system, comprising
a planting assembly, disposed in an indoor space;
multiple light-intensity-variable illuminating devices, configured to illuminate the planting assembly according to a control signal to cause photosynthesis of the planting assembly;
a carbon dioxide detector, configured to detect a carbon dioxide concentration in the indoor space and to emit a concentration signal; and
a controller, signally connected to the illuminating devices and the carbon dioxide detector, the controller being configured to receive the concentration signal and to give the control signal, and the controller being configured to dynamically adjust a light intensity of the illuminating devices according to the concentration signal, thereby dynamically adjusting a photosynthesis efficiency of the planting assembly;
wherein the controller is configured to provide suggestion of suitable planting species and quantity of the planting assembly according to a spatial volume parameter of the indoor space and its maximum number of users, and the controller is configured to determine a relationship between the light intensity of the illuminating devices and the efficiency of photosynthesis of the planting assembly according to the planting species and the quantity thereof.

5. An active indoor planting dynamic carbon dioxide adjustment system, comprising
a planting assembly, disposed in an indoor space;
multiple light-intensity-variable illuminating devices, configured to illuminate the planting assembly according to a control signal to cause photosynthesis of the planting assembly;
a carbon dioxide detector, configured to detect a carbon dioxide concentration in the indoor space and to emit a concentration signal; and
a controller, signally connected to the illuminating devices and the carbon dioxide detector, the controller being configured to receive the concentration signal and to give the control signal, and the controller being configured to dynamically adjust a light intensity of the illuminating devices according to the concentration signal, thereby dynamically adjusting a photosynthesis efficiency of the planting assembly;
wherein the planting assembly includes at least two planting species, and the planting species are different from each other in tolerable carbon dioxide concentration range for photosynthesis.

6. The active indoor planting dynamic carbon dioxide adjustment system of claim 5, further comprising a fan configured to blow towards the planting assembly.

7. The active indoor planting dynamic carbon dioxide adjustment system of claim 1, further comprising a fan signally connected to the controller, the fan being configured to blow towards the planting assembly, the controller is further configured to correspondingly increase or decrease a rotational speed of the fan according to the rate of increase or decrease of the carbon dioxide concentration.
